(19) United States
(12) Patent Application Publication
(10) Pub. No.: US 2017/0352234 A1
(43) Pub. Date: Dec. 7, 2017

(54) SECURITY AND SURVEILLANCE SYSTEM

(71) Applicant: AL RADEEF TECHNOLOGY & SOLUTIONS L.L.C., Amman (JO)

(72) Inventors: MNAWER KHALID MUSTAFA AL AWAYSHEH, Amman (JO); ALA FAIQ RASHED KHZAIE, Amman (JO)

(21) Appl. No.: 15/170,197

(22) Filed: Jun. 1, 2016

(51) Int. Cl. G08B 13/196; H04L 29/08; H04N 7/18

(52) U.S. Cl. CPC G08B 13/19656; H04N 7/188; H04N 7/181; G08B 13/19665; G08B 13/19695; H04L 67/1097

(57) ABSTRACT

A security and surveillance system identifies potential incidents in a target space, creates a report of such incidents, and sends notifications together with the created report to a remote user device. The system may include real-time surveillance devices, sensors, and trigger detectors, wherein the surveillance devices, the sensors, and the trigger detectors are in operable communication with an apparatus having a server, the server may be in communication with a remote user device, and a database.

### TECHNICAL FIELD

The present disclosure relates to security and surveillance systems deployed in target spaces, such as security and surveillance systems that identify potential theft incidents and prevent them from taking place.

### BACKGROUND

Surveillance and security systems are used to keep records of activities and incidents that take place in a specified location.

Among previous security systems, there is provided a security system disclosed in U.S. published patent application no. 2005/0102704, U.S. published patent application no. 2004/0052501, and U.S. Pat. No. 7,859,571.

In surveillance and security systems, it would be useful to be able to review a large number of recorded videos by a surveillance system in order to identify potential incidents, such as thefts, so as to prevent their occurrences.

### BRIEF DESCRIPTION OF THE DRAWINGS

The disclosure will now be described with reference to the accompanying drawings, which illustrate exemplary embodiments of the present disclosure without however restricting the scope and the spirit thereof, and in which:

FIG. 1 illustrates a schematic diagram of a security and surveillance system that identifies potential incidents in a target space, the system being configured in accordance with embodiments of the present invention.

FIG. 2 illustrates a schematic diagram of a security and surveillance system that identifies potential incidents in a target space, the system being configured in accordance with other embodiments of the present invention.

FIG. 3 illustrates a flow diagram of a security and surveillance system and method for notifying a user about a potential incident, the system and method being configured in accordance with embodiments of the present invention.

### DETAILED DESCRIPTION

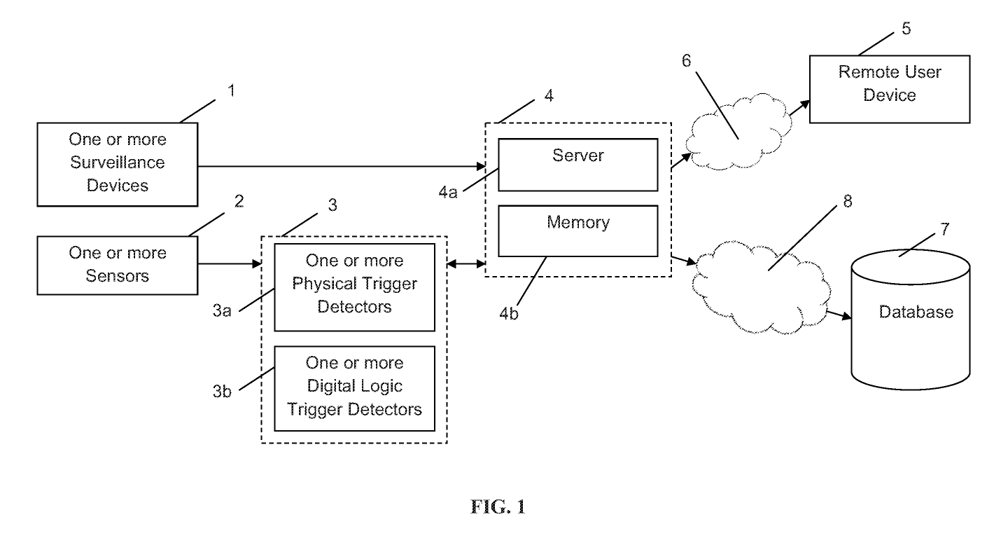

Reference is now being made to FIG. 1, which illustrates a security and surveillance system configured to identify incidents (including activity indicative of the possibility of a potential incident about to occur) in a target space. Such incidents may include activity indicative of a potential crime to be committed, such as a theft of property, etc. However, note that embodiments of the present invention may be configured to identify (and possibly record and/or report) any type of activity the user desires to identify, whether it involves criminal activity or not. The system may include one or more surveillance devices 1 (which may be configured to operate substantially in real-time), one or more sensors 2, one or more trigger detectors 3, and an apparatus 4, with a server 4a and associated memory device 4b, in communication with the one or more surveillance devices 1 and the one or more trigger detectors 3. The system of the present disclosure may further include a remote user device 5 in communication with the apparatus 4 over a first network 6, and/or a database 7 in communication with the apparatus 4 over a second network 8. The system may be included as part of a point of sale, inventory, closed circuit television, alarm, radio frequency, and radio frequency identification system (collectively referred to herein as “PICARS”).

In embodiments of the present disclosure, the surveillance devices 1 may include cameras (still and/or video) configured to capture (for example, in a substantially continuous manner) and feed (i.e., transfer) images (for example, real-time) taken of a target space to the apparatus 4.

In embodiments of the present disclosure, the one or more sensors 2 may include one or more proximity sensors (for example, positioned at selected locations within the target space (such as at one or more cash registers)), one or more radio frequency/amplitude modulation (“RF/AM”) sensors, one or more motion detectors distributed at selected areas in a target space, and/or one or more power failure sensors (for sensing a power outage occurring in the target space) configured to send trigger signals to the one or more trigger detectors 3. In embodiments of the present disclosure, the target space could be a retail store, wherein the RF/AM sensors are located at the gates, or front doors, of the retail store, and are configured to send trigger signals to the one or more trigger detectors 3 when at least one item for sale within the store possessing an activated tag (for example, an RFID tag) passes through the gates. Note in embodiments of the present disclosure, the target space may be any open or enclosed space (for example, a room, building floor, facility, fenced or walled area), and is not limited to a retail store.

The one or more trigger detectors 3 may include one or more physical trigger detectors 3a and one or more digital logic trigger detectors 3b, wherein the one or more physical trigger detectors 3a may be in communication with the one or more sensors 2, and may send trigger signals to the apparatus 4 when at least one pre-defined condition is met (also referred to herein as a “trigger” or “trigger activation”). For instance, such a condition may include a cash register drawer remaining open for a period of time exceeding a pre-defined length. In embodiments of the present disclosure, the one or more digital logic trigger detectors 3b may be in communication with one or more pre-installed systems in the target space (such as an Enterprise Resource Planning (“ERP”) system in a retail store), and may be configured to send signals to the apparatus 4, which may be configured to create a report when at least one pre-defined condition is met. Such pre-defined conditions may be defined based on the user's desire, and may depend upon the nature of the target space. Exemplary pre-defined conditions may include, but are not limited to, selling of a certain specified item in a retail store, or issuing an invoice with an amount greater than a pre-set value.

In embodiments of the present disclosure, the apparatus 4 may include a computer server 4a and a memory 4b, wherein the server 4a may be configured to receive the images captured by the surveillance devices 1 and store such images in a sequence of files (for example, in video format), wherein each file may represent a pre-defined period of time (for example, one minute). Each file may be stored in the memory 4b, and may include a title (for example, representing a timestamp of such file). When the apparatus 4 receives a trigger signal (indicating the occurrence of a trigger) from any of the one or more trigger detectors 3, the server 4a may be configured to identify and locate one or more of the video files stored within the memory 4b containing a moment of time (for example, a predetermined time period) in which the trigger occurred. Then, the server 4a may be configured to create a pre-defined report indicating the occurrence of a certain activity the user of the system desires to be notified about (for example, activity that may be indicative of the possibility of an occurrence of a potential theft incident).

During the creation of such a report, the server 4a may be configured to extract images from the identified video file(s), which may include scenes of pre and post trigger activation (i.e., image(s) occurring during pre-defined time periods before and/or after when the trigger occurred (for example, before and/or after receipt by the server 4a of the trigger signal from one of the trigger detectors 3)), wherein the length(s) of the images being extracted may be determined based on the user's preference and/or depending on the nature of the target space.

In embodiments of the present disclosure, the server 4a may be configured to send a notification, which may include the created report containing the extracted image(s), to the remote user device 5 over the first network 6. The remote user device may be configured to receive the notification from the server 4a, and may be configured to enable the user to view the report. Such a configuration may be achieved through installing a software application on the user device 5 (for example, a smart phone or web-based application).

The server 4a may also be optionally configured to send the created report to be recorded or stored (for example, for back up purposes) on the database 7 over the second network 8. The database 7 may be a database dedicated to the system, or a virtual database (for example, storage on the Internet cloud).

The server 4a may include at least one well-known and appropriately configured communication module (not shown) that enables the server 4a to send the notification and/or the report over the first network 6 to the remote user device 5, and to send the report to the database 7 over the second network 8.

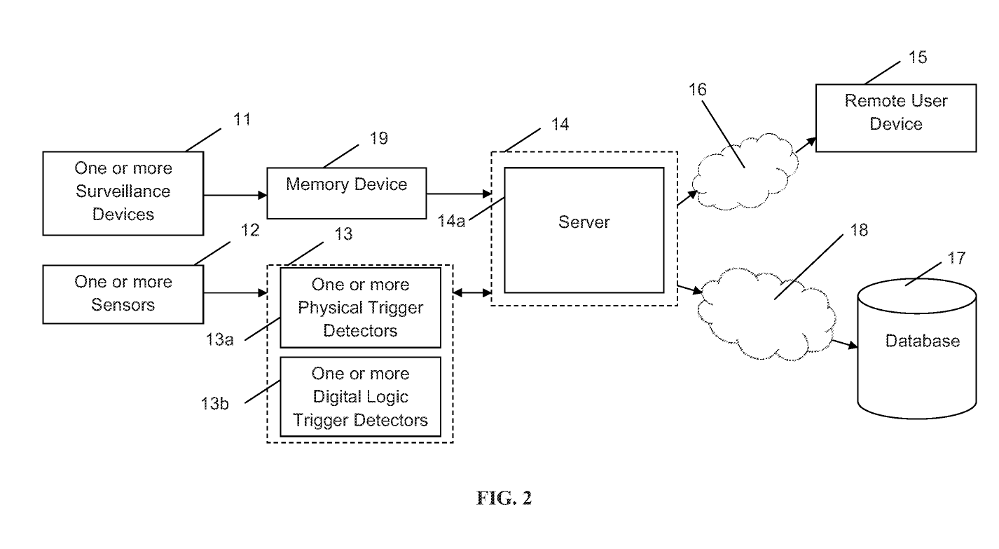

Reference is now being made to FIG. 2, which illustrates a security and surveillance system configured to identify incidents (including activity indicative of the possibility of a potential incident about to occur) in a target space. Such incidents may include activity indicative of a potential crime to be committed, such as a theft of property, etc. However, note that embodiments of the present invention may be configured to identify (and possibly record and/or report) any type of activity the user desires to identify, whether it involves criminal activity or not. The system may include one or more surveillance devices 11 (which may be configured to operate substantially in real-time) in communication with a memory device 19, one or more sensors 12, one or more trigger detectors 13, and an apparatus 14, with a server 14a, in communication with the memory device 19 and the one or more trigger detectors 13. The system of the present disclosure may further include a remote user device 15 in communication with the apparatus 14 over a first network 16, and/or a database 17 in communication with the apparatus 14 over a second network 18. The system may be included as part of a PICARS.

In embodiments of the present disclosure, the surveillance devices 11 may include cameras (still and/or video) configured to capture (for example, in a substantially continuous manner) and feed (i.e., transfer) images (for example, real-time) taken of a target space to the memory device 19, wherein the memory device 19 is configured to receive the images captured by the surveillance devices 11 and store such images in a sequence of files (for example, in a video format), wherein each file may represent a pre-defined period of time (for example, one minute). Each file may be stored in the memory device 19, and may include a title (for example, representing a timestamp of such file).

In embodiments of the present disclosure, the one or more sensors 12 may include one or more proximity sensors (for example, positioned at selected locations within the target space (such as at one or more cash registers)), one or more radio frequency/amplitude modulation (“RF/AM”) sensors, one or more motion detectors distributed at selected areas in a target space, and/or one or more power failure sensors (for sensing a power outage occurring in the target space) configured to send trigger signals to the one or more trigger detectors 13. In embodiments of the present disclosure, the target space could be a retail store, wherein the RF/AM sensors are located at the gates, or front doors, of the retail store, and are configured to send trigger signals to the one or more trigger detectors 13 when at least one item for sale within the store possessing an activated tag (for example, an RFID tag) passes through the gates. Note in embodiments of the present disclosure, the target space may be any open or enclosed space (for example, a room, building floor, facility, fenced or walled area), and is not limited to a retail store.

The one or more trigger detectors 13 may include one or more physical trigger detectors 13a and one or more digital logic trigger detectors 13b, wherein the one or more physical trigger detectors 13a may be in communication with the one or more sensors 12, and may send trigger signals to the apparatus 14 when at least one pre-defined condition is met (also referred to herein as a “trigger” or “trigger activation”). For instance, such a condition may include a cash register drawer remaining open for a period of time exceeding a pre-defined length. In embodiments of the present disclosure, the one or more digital logic trigger detectors 13b may be in communication with one or more pre-installed systems in the target space (such as an Enterprise Resource Planning (“ERP”) system in a retail store), and may be configured to send signals to the apparatus 14, which may be configured to create a report when at least one pre-defined condition is met. Such pre-defined conditions may be defined based on the user's desire, and may depend upon the nature of the target space. Exemplary pre-defined conditions may include, but are not limited to, selling of a certain specified item in a retail store, or issuing an invoice with an amount greater than a pre-set value.

In embodiments of the present disclosure, the apparatus 14 may include a computer server 14a configured to communicate with the memory device 19. When the apparatus 14 receives a trigger signal (indicating the occurrence of a trigger) from any of the one or more trigger detectors 13, the server 14a may be configured to identify and locate one or more of the video files stored within the memory device 19 containing a moment of time in which the trigger occurred. Then, the server 14a may be configured to create a pre-defined report indicating the occurrence of a certain activity the user of the system desires to be notified about (for example, activity that may be indicative of the possibility of an occurrence of a potential theft incident).

During the creation of such a report, the server 14a may be configured to extract images from the identified video file(s), which may include scenes of pre and post trigger activation (i.e., image(s) occurring during pre-defined time periods before and/or after when the trigger occurred (for example, before and/or after receipt by the server 14a of the trigger signal from one of the trigger detectors 13)), wherein the length(s) of the image(s) being extracted may be determined based on the user's preference and/or depending on the nature of the target space.

In embodiments of the present disclosure, the server 14a may be configured to send a notification, which may include the created report containing the extracted image(s), to the remote user device 15 over the first network 16. The remote user device may be configured to receive the notification from the server 14a, and may be configured to enable the user to view the report. Such a configuration may be achieved through installing a software application on the user device 15 (for example, a smart phone or web-based application).

The server 14a may also be optionally configured to send the created report to be recorded or stored (for example, back up purposes) on the database 17 over the second network 18. The database 7 may be a database dedicated to the system, or a virtual database (for example, storage on the Internet cloud).

The server 14a may include at least one well-known and appropriately configured communication module (not shown) that enables the server 14a to send the notification and/or the report over the first network 16 to the remote user device 15, and to send the report to the database 17 over the second network 18.

In embodiments of the present disclosure, the memory 19 may be a well-known Digital Video Recorder (“DVR”) or a well-known Network Video Recorder (“NVR”).

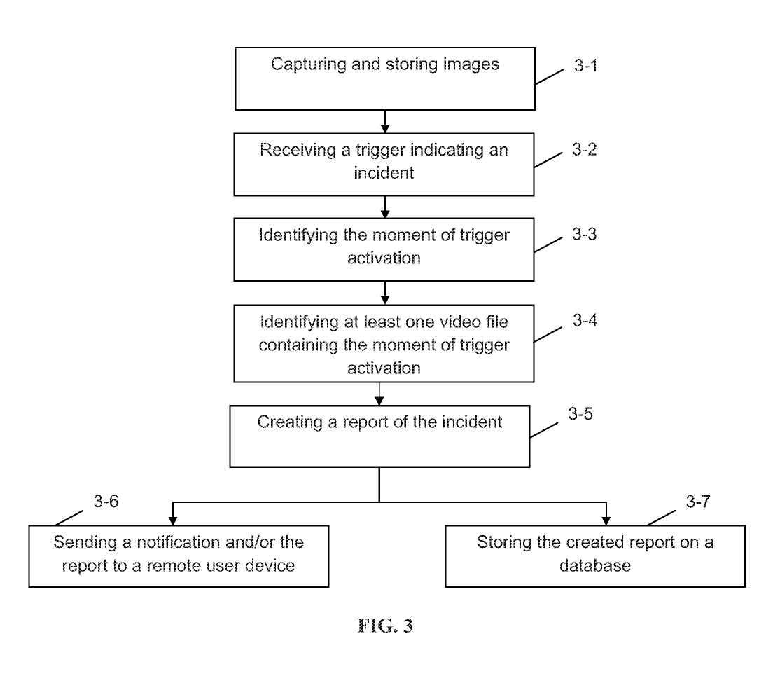

Referring now to FIG. 3, there is illustrated a flow diagram of a method configured to notify a user about incidents (including activity indicative of the possibility of a potential incident about to occur) in a target space. Such a method may be implemented in either of the systems described with respect to FIGS. 1 and 2.

In process block 3-1, images, which may be captured in real time, may be captured by one or more surveillance devices distributed in a target space, wherein the captured images may be stored (for example, in sequential files of video format) on a memory device.

In process block 3-2, at least one trigger detector may receive a trigger signal indicating the occurrence of a trigger, which may be indicative of an incident (including activity indicative of the possibility of a potential incident about to occur).

In process block 3-3, an apparatus having a server may identify the moment in time (for example, a time period) containing the trigger activation.

In process block 3-4, at least one video file (or merely a file containing image(s)) identified by the server may be stored on a memory, which may contain the moment in time of the trigger activation.

In process block 3-5, a report of the potential incident may be created by the server, wherein the report may include image(s) for a pre-defined period of time being extracted from at least image file stored on the memory.

In process block 3-6, the created report may be sent by the server with a notification to a remote user device over a first network.

In process block 3-7, the created report may be sent by the server to a database over a second network, such as for back up purposes.

In embodiments of the present disclosure, the stored sequence of files described herein may have similar pre-defined lengths, and may be stored with titles representing timestamps of such files. The identification of the file containing the moment in time of the trigger activation may be performed by the server exploring a video (or image) having a timestamp that includes the time at which the trigger is activated.

In embodiments of the present disclosure, the memory device 19 may be one or more stand-alone components (such as a DVR or an NVR), or may be embedded with the apparatus implementing the server. In embodiments of the present disclosure, the first network 6, 16 and/or the second network 8, 18 may be any type of network (for example, wired, wireless, cellular, land line). In embodiments of the present disclosure, the first network 6, 16 and the second network 8, 18 may be included in the same network. In embodiments of the present disclosure, the remote user device 5, 15 may be a smart phone, tablet device, computer, etc. In embodiments of the present disclosure, the database may be a physical database or a virtual database (for example, the Internet cloud).

In embodiments of the present disclosure, the remote user device 5, 15 may be configured to enable the user to receive the notification and/or view the created report, wherein such a configuration may be achieved through installing a software application on the user device 5, 15 (for example, a smart phone or web-based application). The surveillance devices 1, 11 may be any image capturing device capable of capturing images of any useable wavelengths, including visible light, infrared, ultraviolet, etc.

While embodiments of the disclosure have been described in detail and with reference to specific embodiments thereof, it will be apparent to one skilled in the art that various additions, omissions, and modifications can be made without departing from the spirit and scope thereof. Although the above description contains some specificity, these should not be construed as limitations on the scope of the invention, but is merely representative of the disclosed aspects of the present disclosure.

Aspects of the present disclosure may be a system, a method, and/or a computer program product at any possible technical detail level of integration. The computer program product may include a computer readable storage medium (or media) having computer readable program instructions thereon for causing a processor (such as implemented within the server 4a, 14a) to carry out aspects of the present disclosure.

The computer readable storage medium can be a tangible device (for example, a memory implemented within the server 4a, 14a) that can retain and store instructions for use by an instruction execution device (for example, the server 4a, 14a). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network (for example, see networks 6, 8, 16, and 18). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of aspects of the present disclosure may be assembler instructions, instruction-set-architecture (“ISA”) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present disclosure.

Aspects of the present disclosure may be described herein with reference to flow diagram illustrations and/or block diagrams of methods, apparatus (systems), and computer program products according to embodiments of the invention. It will be understood that each block of the flow diagram illustrations and/or block diagrams, and combinations of blocks in the flow diagram illustrations and/or block diagrams, can be implemented by computer readable program instructions.

These computer readable program instructions may be provided to a processor (for example, the server 4a, 14a) of a general purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow diagram and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flow diagram and/or block diagram block or blocks.

The flow diagram and block diagrams in the Figures illustrate the architecture, functionality, and operation of possible implementations of systems, methods, and computer program products according to various embodiments of the present invention. In this regard, each block in the flow diagram or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flow diagram illustration, and combinations of blocks in the block diagrams and/or flow diagram illustration, can be implemented by special purpose hardware-based systems that perform the specified functions or acts or carry out combinations of special purpose hardware and computer instructions.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the terms “about” or “approximately” are used to indicate that a value includes the inherent variation of error for the device, the method being employed to determine the value, or the variation that exists among the study subjects.

What is claimed is:

1. A system for identifying an incident in a target space, the system comprising:
one or more surveillance devices deployed in the target space;
one or more sensors deployed in the target space;
one or more trigger detectors configured to communicate with the one or more sensors; and
an apparatus implementing a server communicating with the one or more surveillance devices and the one or more trigger detectors, wherein the apparatus is configured to create a report of the identified incident using an output of the one or more surveillance devices whenever a trigger is detected by the one or more sensors, and send a notification that the identified incident has occurred together with the created report to a remote user device over a first network.

2. The system of claim 1, wherein said target space comprises a retail store.

3. The system of claim 1, wherein said one or more surveillance devices comprise one or more cameras.

4. The system of claim 1, wherein said one or more sensors are selected from a group consisting of proximity sensors, Radio Frequency/Amplitude modulation sensors, motion detectors, and power failure sensors.

5. The system of claim 1, wherein said one or more trigger detectors are selected from a group consisting of physical trigger detectors in communication with the one or more sensors, and digital logic trigger detectors in communication with a pre-installed management system.

6. The system of claim 1, wherein said server is configured to store outputs of the surveillance devices in video format as a series of sequential files, wherein a length of each file is pre-determined, and wherein titles of the files represent timestamps of such files.

7. The system of claim 1, wherein the apparatus is configured to create the report of the identified incident by extracting images from the output of the one or more surveillance devices, wherein the images pertain to a moment of time containing the trigger.

8. The system of claim 1, wherein said remote user device comprises a smart phone configured to receive and display the notification and the report.

9. The system of claim 1, further comprising a memory device configured to store the output of the one or more surveillance devices in video format, wherein the server is in communication with the memory device.

10. The system of claim 1, wherein the apparatus is configured to send the created report for storage on a database over a second network.

11. A method for notifying a user about a potential incident, the method comprising:
capturing images by a surveillance device deployed within a target space;
storing the captured images on a memory device;
receiving by a trigger detector a trigger indicating the potential incident;
identifying a time in which the trigger is activated,
identifying which of the captured images contain an image during the time in which the trigger is activated;
creating a report of the potential incident by extracting images from the stored captured images, wherein the images in the report pertain to the time in which the trigger is activated; and
sending the created report with a notification to a remote user device over a first network.

12. The method of claim 11, wherein said trigger detector comprises a physical trigger detector in communication with a sensor.

13. The method of claim 11, wherein said trigger detector comprises a digital logic trigger detector in communication with a pre-installed management system.

14. The method of claim 11, wherein the images being extracted from the stored captured images include an image captured during the trigger activation with pre and post trigger activation images.

15. The method of claim 11, wherein said remote user device comprises a smart phone configured to receive and display the notification and the report.

16. A computer program product stored on a computer readable storage medium, which when executed, performs a method for notifying a user about a potential incident, the method comprising:
storing on a memory device images captured by a surveillance device deployed within a target space;
receiving by a trigger detector a trigger indicating the potential incident;
identifying a time in which the trigger is activated;
identifying which of the captured images contain an image during the time in which the trigger is activated;
creating a report of the potential incident by extracting images from the stored captured images, wherein the images in the report pertain to the time in which the trigger is activated; and
sending the created report with a notification to a remote user device over a first network.

17. The computer program product of claim 16, wherein said trigger detector comprises a physical trigger detector in communication with a sensor.

18. The computer program product of claim 16, wherein said trigger detector comprises a digital logic trigger detector in communication with a pre-installed management system.

19. The computer program product of claim 16, wherein the images being extracted from the stored captured images include an image captured during the trigger activation with pre and post trigger activation images.

20. The computer program product of claim 16, wherein said remote user device comprises a smart phone configured to receive and display the notification and the report.
